(19) United States
(12) Patent Application Publication
(10) Pub. No.: US 2002/0183017 A1
(43) Pub. Date: Dec. 5, 2002

(54) Cellular telephone digital recorder

(76) Inventor: Charles Otway Mujica, Coral Gables, FL (US)

Correspondence Address: CHARLES OTWAY MUJICA, P.O. BOX 140012, CORAL GABLES, FL, 33114-0012, US

(21) Appl. No.: 10/144,552

(22) Filed: May 13, 2002

Related U.S. Application Data
(60) Provisional application No. 60/296,852, filed on Jun. 5, 2001.

(51) Int. Cl. H04B 1/38

(52) U.S. Cl. 455/90; 455/575; 455/412

(57) ABSTRACT

A combination Cellular Telephone and Digital Recorder Device that is used to make and receive telephone calls, save telephone calls, and to record telephone conversations while speaking through the phone comprising of speakers in order to listen to the conversation(s) either privately by the user(s) or at loud for others persons to listen. It includes a resting alternate stand piece for the device to rest; ear phone jack; battery charger jack; recorder ear jack; recorder digital features; and a telescoping antenna with the option to articulate the antenna or not, that permits a better communication sound waives depending of the area; Also, includes a holder hook to carry the device; and a telephone cover that has a lip at the edge; that has the function of opening and closing to protect the device. Same telephone cover has a Window magnifier for a better view for incoming calls; and menu/folder of the telephone display.

The present invention has a special loop handle preventing the device to slip through the hands; Also comprised with a luminic panel of multitude digital numbers on a vertical position design, additionally with variable letters and symbols.

### BACKGROUND OF THE INVENTION

1. Field of the Invention

The present invention relates to a Cellular Telephone Digital Recorder, and more particularly to a manual portable cordless Digital Telephone with the special function of recording a telephone conversation while speaking through the Cellular Telephone Digital Recorder between the caller and the receiver parties.

2. Description to the Related Art

Many designs for Cellular Telephones have been designed in the past. These designs are used without recording telephone conversations. The present solution helps a user to make and receive telephone calls, save telephone calls and records telephone conversations between the caller and the receiver parties while having a telephone conversation through the digital cellular telephone without any limitations of using another similar cellular phone, a base station or a telephone station adapter. Other designs incorporating the closest subject matter provide for a number of more or less complicated features that fail to solve the problem in an efficient, and convenient matter with the most sophisticated technology for Cellular Telephones. Also comprised with a luminic panel in a unique design of multitude digital numbers on a vertical position design, additionally with variable letters and symbols. (Design Patent D454123). None of the past designs suggest the novel features of the present invention.

### SUMMARY OF THE INVENTION

It is one of the main objects of the present invention to record telephone conversations while speaking through the cellular telephone digital recorder between the caller and the receiver parties.

It is another object of this invention to be used without any limitations of using another similar cellular phone, a base station or a telephone station adapter.

It is still another object of the present invention to provide a luminic panel/key pad of multitude digital numbers on a vertical position design (Design Patent D454123), additionally with variable letters and symbols.

It is yet another object of this invention to have the option to select which conversation(s) the user(s) records and which conversation(s) the user(s) wants to listen.

It is another object of the present invention to listen to the conversation(s) either privately by the user(s) or at loud for other persons to listen.

Another object of the present invention is that includes a resting alternate stand piece for the device to rest, ear phone jack, battery charger jack, recorder jack, recorder digital features, inclusive of a telescoping extensible antenna with the option to articulate the antenna or not, that permits a better communication sound waives depending of the area.

A further object of the instant invention is that includes a holder hook to carry the device, and a cover that has a lip at the edge, that has the function of opening and closing to protect the device.

And yet a further object of the present invention is that it has a special loop handle preventing the device to slip.

Another object of the present invention is that it has a telephone LCD display that permits to view multiple features.

It is yet another object of the present invention that it has a digital recorder LCD display that permits to view multiple features.

It is yet another object that has a telephone cover with a window magnifier for a better view for incoming calls, and menu/folder of the telephone display.

It is another object of the present invention that has a LED advising when the battery is low.

Further objects of the invention will be brought out in the following part of the specification, wherein detailed description is for the purpose of fully disclosing the invention without placing limitation thereon.

BRIEF DESCRIPTION OF THE DRAWINGS

With the above and other related objects in view, the invention consists in the details of construction and combination of parts as will be more fully understood from the following description, when read in conjuction with the accompanying drawings in which:

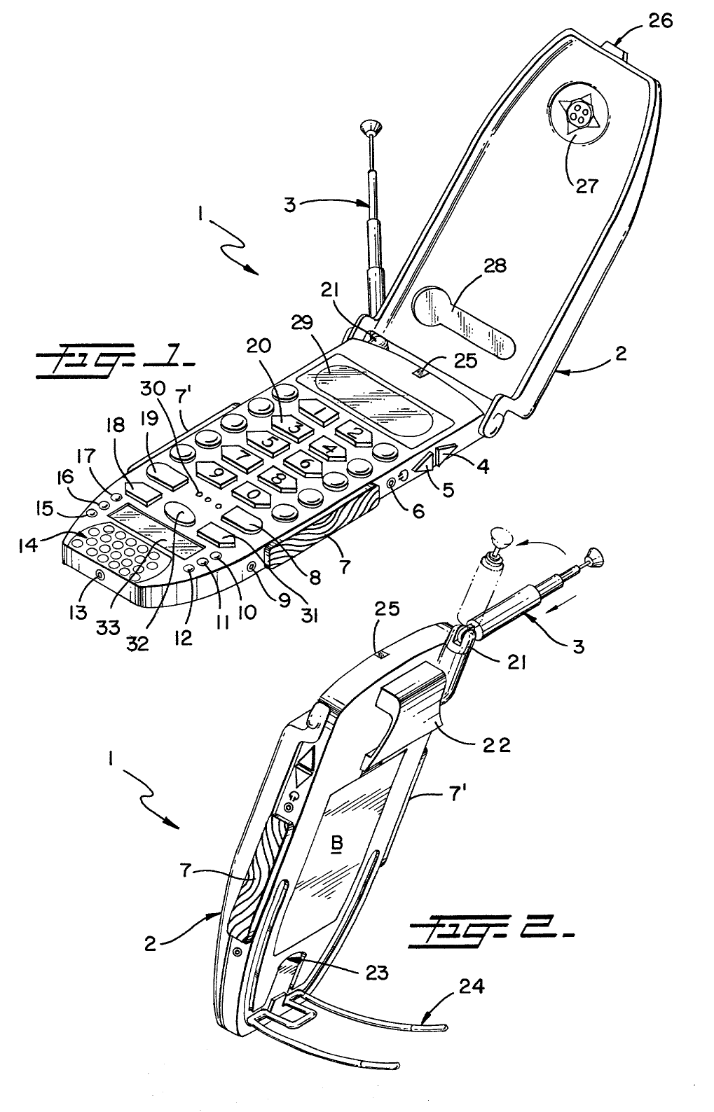

FIG. 1 is an isometric view, in an alternate position for use;

FIG. 2 is an isometric view, in an alternate position for use, and

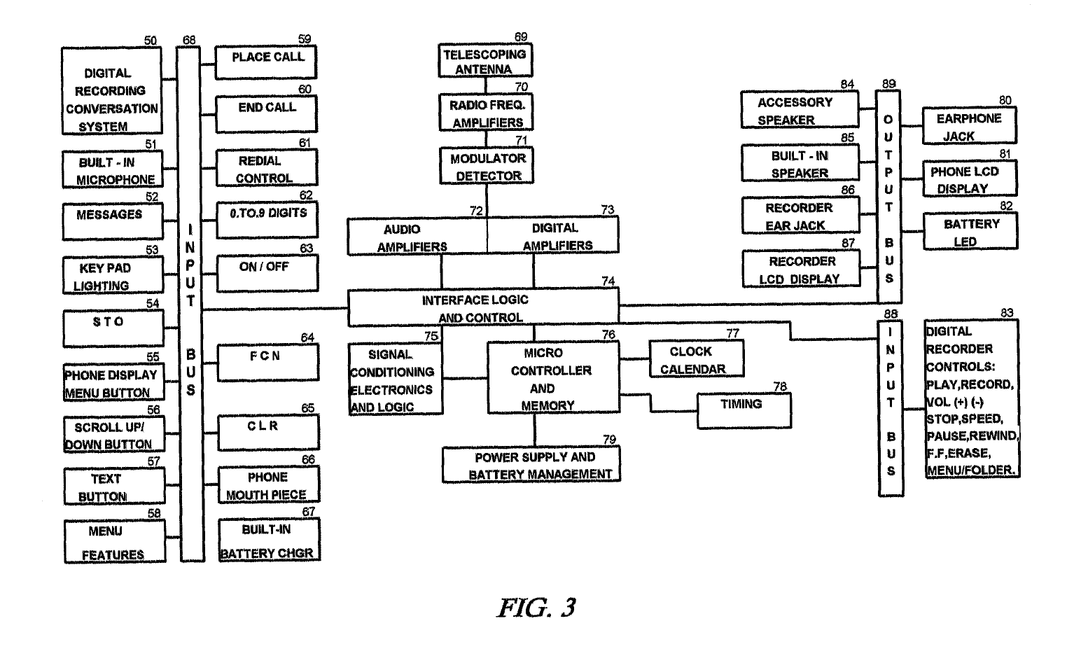

FIG. 3 is an schematic electronic block diagram of the device of FIG. 1 and FIG. 2.

### DETAILED DESCRIPTION OF TIE PREFERRED EMBODIMENT

This invention relates to a Cellular Telephone Digital Recorder which is made of any suitable plastic, rubber, metal materials, and electronic components.

Referring now to the drawings, where the present invention is referred to FIG. 1, FIG. 2, and FIG. 3 it comprises of the following:

A Telephone cover that has the function of opening and closing to protect the device 2, a telescoping antenna with the option to be articulated permitting a better communication sound waives depending of the area 3, window LCD telephone display luminic buttons 4 and 5, earphone jack 6, special loop handle to prevent the device to slip 7 and 7′, record button 8, recorder ear jack 9, Menu/folder button 10; erase button 11; forward (F.F.) button 12; battery charger jack 13; speaker vent 14; rewind (rew) button 15; pause button 16; speed control button 17; volume (+) maxim control button 18; play button 19; luminic panel/key pad with multiple digital numbers on a vertical position design, additionally with variable letters and symbols 20; antenna piece holder 21; holder hook 22; rest piece cavity that is used to pull the rest piece 23; rest piece 24; battery LED 25; lip cover to open an close the device 26; receiver 27; window magnifier 28; LCD telephone display 29; transmitter 30; volume (−) minimum control button 31; stop button 32; luminic LCD digital recorder display 33; and battery B.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A combination Cellular Telephone and Digital Recorder Device, the combination comprising:
a built-in microphone means for extra convenience eliminating the need for an external microphone. Said built-in microphone that is connected contiguously to a transmitter receiver, in order to provide the option to the user to record a telephone conversation by using the play and record buttons or to speak without recording the conversation a/o sounds;
a clock calendar means joined to said controller means for generating information related to time, date, alarm and for inputting said information into said controller means;
a control mechanism for selectively controlling telephone features;
a key pad lighting input for said controller means, said key pad input having several keys and adapted to program said memory with the correspondent context to store one or more telephone numbers to be use to place a call, the time, date that the telephone calls must take place and the alarm joined to said key pad advises the user, means that the luminic panel of said key pad lights-up when the call is ready to be placed;
an alarm means joined to said controller means and agreeable to said clock calendar means for creating a flashing alarm warning of the telephone numbers to be use to place a call, and the time and date that the telephone calls must take place;
a receiver transmittal to receive and to place incoming and outgoing calls;
a controller means having a memory storing data and commands which define operations on said data and having logic means for processing said data;
an interface logic and control electronic connection means for interfacing electronically said controller means and said telephone system;
output means agreeable to said alarm flashing warning indicating that a respective telephone number is ready to place a call;
a speaker with an associated volume control button means for adjusting the volume of audio sinals emitted therefrom;
a battery led means to provide a visible signal when battery strength is low;
a telephone stand that opens and closes means that said stand provides an option to the user to keep the telephone standing when said stand is in the open position or to keep the telephone resting when said stand is in the close position inside the rest piece cavity;
a telephone holder hook that provides the user to carry the telephone means that said telephone holder hook is attached to a desire place;
a telescoping antenna with the option to be articulated said antenna permits a better communication sound waives depending of the area and
a window magnifier means for a better view for incoming calls, and menu/folder of the telephone display.

2. A combination Cellular Telephone Device and Digital System according to claim 1, including a control mechanism, wherein said control means play, record, volumes (+/−), stop, speed, pause, rewind, fast forward, erase, menu/folder.

3. A combination Cellular Telephone Device and Digital System according to claim 1 including an automatic redial means for redialing a telephone number that has been programmed until the call is completed.

4. A combination Cellular Telephone Device and Digital System according to claim 1 including speakers that are connected to the transmittal/receiver when the user desires to hear the conversation means by pressing the play button.

5. A combination Cellular Telephone Device and Digital System according to claim 1 including a digital recorder that has a function to record telephone conversations while speaking through the cellular telephone and/or sounds by the users means that these system can record telephone conversations in digital pulses which can be stored and duplicated without degradation on the digital recorder system;

6. A combination cellular telephone Device and Digital System according to claim 2, including a control mechanism, wherein said control means place call, end call, redial control, 0. to 9 digits, on/off, fcn, clr, scroll memory entries, menu, text button, scroll up/down buttons, phone display menu buttons, sto.
